(19) United States
(12) Patent Application Publication
(10) Pub. No.: US 2025/0307972 A1
(43) Pub. Date: Oct. 2, 2025

(54) METHOD AND SYSTEM FOR BOARDING AN AIRPLANE

(71) Applicant: David Edward Henry, Cedar Falls, IA (US)

(72) Inventor: David Edward Henry, Cedar Falls, IA (US)

(21) Appl. No.: 18/621,115

(22) Filed: Mar. 29, 2024

(51) Int. Cl. G06Q 50/40

(52) U.S. Cl. CPC G06Q 50/40

(57) ABSTRACT

According to the present invention disclosed herein, there is provided a method of using an aircraft, comprising: a) a last row window seat passenger on a first side boarding the aircraft first; b) followed by the second to last row window seat passenger on the opposite side boarding the aircraft next; c) the third to last row window seat passenger on the first side boarding the aircraft next; d) continuing boarding such that window seat passengers board from the back of the plane to the front in each group of passengers comprising passengers on the first side and in the next row forward on the alternate side; e) following the same procedure in a-d by one or more groups of middle seat passengers next; and f) following the procedure in a-d by one or more groups of aisle seat passengers last.

### BACKGROUND

A number of individuals have developed procedures and inventions to simplify and shorten the boarding process for an airplane.

Buschi, Coulomb, Gibault, and Palaysi (US 2006/0206353, 14 Sep. 2006) designed a virtual destination locator to speed boarding passengers to their seats. To speed up the boarding process, Yun Zhao (US 2006/0278764 A1, 14 Dec. 2006) proposed zone boarding by seat location-boarding passengers in window seats first, middle seats next, and aisle seats last.

U.S. Pat. No. 8,618,909 describes queue control gates so that passengers must pass through them before reaching the boarding gate. The queue control gates select passengers for boarding in a sequence that minimizes boarding difficulties. Passengers queue up behind the queue control gates, and the controller selects the passengers for boarding based on their passenger information (e.g. seat assignment). The airline may program the controller for various types of aircraft and for any number of different boarding strategies. When selected, a passenger leaves the queue control gate, moves through the boarding gate and into the aircraft. This apparatus ensures that at least the number of passengers equal to the number waiting at the queue control gates do not interfere with each other during the seating process. In this way, the controller arranges the passengers in a sequence that minimizes boarding time.

However, prior art boarding methods and systems have been found to be less than optimal in practice, and substantial cost reductions and efficiencies could be realized with improvements.

### SUMMARY OF INVENTION

Therefore, the present invention provides a system and computer-implemented method which is very different than those used by airlines currently.

According to one aspect of the present invention, there is provided a method of using an aircraft, comprising: a) a last row window seat passenger on a first side boarding the aircraft first; b) followed by the second to last row window seat passenger on the opposite side boarding the aircraft next; c) the third to last row window seat passenger on the first side boarding the aircraft next; d) continuing boarding such that window seat passengers board from the back of the plane to the front in each group of passengers comprising passengers on the first side and in the next row forward on the alternate side; e) following the same procedure in a-d by one or more groups of middle seat passengers next; and f) following the procedure in a-d by one or more groups of aisle seat passengers last.

According to another aspect of the present invention disclosed herein, there is provided a computer-assisted method for using an aircraft, comprising: storing logic to minimize interference in seating configurations between passengers while passengers are taking their seats; storing a flight seating chart for an aircraft on a computer-readable memory device; and assigning, by using a processor to evaluate the computer memory device based on the stored logic, original boarding numbers for each seat in the flight seating chart to minimize interference.

### BRIEF DESCRIPTION OF THE DRAWINGS

FIG. 1 is an illustration of a passenger manifest according to an embodiment of the present invention for a flight on an airliner.

FIG. 2 is an illustration of a seating chart for an airliner with assignments of an initial boarding order calculated as optimal by computer-implemented method and system of the present invention.

FIG. 3 is an illustration of a seating chart for an airliner with assignments of an initial boarding order calculated as optimal by computer-implemented method and system of the present invention taking into account the needs of passengers traveling together and other airline business considerations such as rewarding high-value customers with priority boarding.

FIG. 4 illustrates a step in a boarding process used with embodiments of the present invention.

FIG. 5 illustrates another step in a boarding process used with embodiments of the present invention.

FIG. 6 illustrates another step in a boarding process used with embodiments of the present invention.

FIG. 7 illustrates another step in a boarding process used with embodiments of the present invention.

FIG. 8 illustrates a boarding pass used with embodiments of the present invention.

### DETAILED DESCRIPTION

Boarding an aircraft or other similar vehicles is often time-consuming because passengers must wait for those in front of them to store their luggage and take their seats. In an attempt to ameliorate this problem, airlines have adapted several boarding strategies-back-to-front aircraft boarding, window-to-aisle boarding sequences, etc. However, none of these methods solves the problem of reducing passenger seat and row interference.

Airline cabins are frequently classified as narrow-body if there is a single aisle with seats on either side, or wide-body if there are two aisles with a block of seats between them in addition to the seats on the sides. The number of seats abreast is affected by the aircraft width. There are a large number of possible seating layouts, such as 2-2, 3-3, 2-3 for a single aisle plane, and 2-2-2, 3-4-3, 2-5-2, and 3-3-3, for a twin-aisle plane. Some aircraft may also have multiple decks of seats.

The computer-implemented method and system of the present invention enables taking a seating chart for an airliner, which can be a wide variety of configurations as described above, and calculating a boarding order which allows for an entire line of passengers the length of the seating area of the fuselage to stow their overhead luggage simultaneously then sit down simultaneously so that once seated, no passenger will have to get up from their seat to allow, for example, a window or middle seat passenger to go to their seat, and no passenger has to wait in the aisle for a passenger to stow their overhead luggage before they can proceed down the aisle to their row. Each passenger usually has two groups wait until the next passenger sits next to them, giving them time to get situated in their seat.

The computer-implemented method and system of the present invention addresses the need to allow passengers traveling together, e.g., parents and their children, to board an aircraft at the same time. Per the preferred use of the system, each seat corresponds to an Original Boarding Number. The software takes all passengers with the same Record Locator (same ticket/family), and it assigns them each the same Final Boarding Number based on the lowest Original Boarding Number that any of them have. Thus, if a mother, father, and child have Original Boarding Numbers of 1, 70, and 210 based on their seat numbers, the software would assign each of them Final Boarding Number 1, and they would board the plane together in Group 1.

The computer-implemented method and system of the present invention also addresses empty seats. Seats which are empty because they have not been sold can be ignored, i.e., the boarding order of the remaining seats can simply be renumbered by subtracting the number of empty seats, or the computer-implemented method and system can recalculate an optimum configuration without the empty seats.

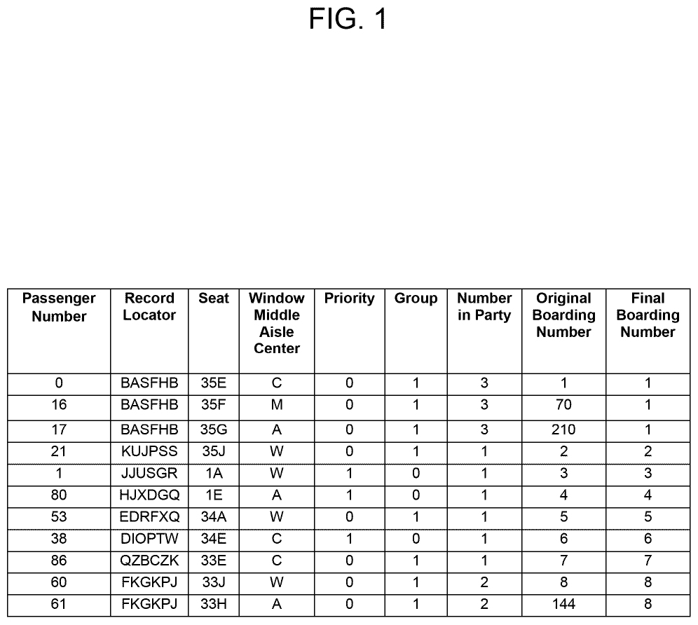

FIG. 1 is an illustration of a passenger manifest according to an embodiment of the present invention for a flight on an airliner.

The following fields are illustrated in FIG. 1.
Original Boarding Number: Based on the Seat on the plane.
Passenger Number: Could be assigned based on the order in which the ticket was purchased.
Record Locator: 6 random letters; assigned per the airline's current method.
Seat: Selected by the passenger or assigned by the airline, per their current method.
Window, Middle, Aisle, Center: Based on the passenger's seat and the plane's seating configuration.
Priority (P) is either 0 for no priority or 1 for yes priority. Alternatively, the airline could subdivide into multiple priority categories.
Group: Group 0 is priority passengers. Group 1 is passengers with Boarding numbers 1-69 (the first set of window passengers to board the airplane as per the efficient boarding system). Groups 2-5 are additional sets of passengers to board efficiently.
Number in Party: Used to identify parties of 2 or more people.
Final Boarding Number: Changed to the lowest Original Boarding Number of anyone in their party/family.

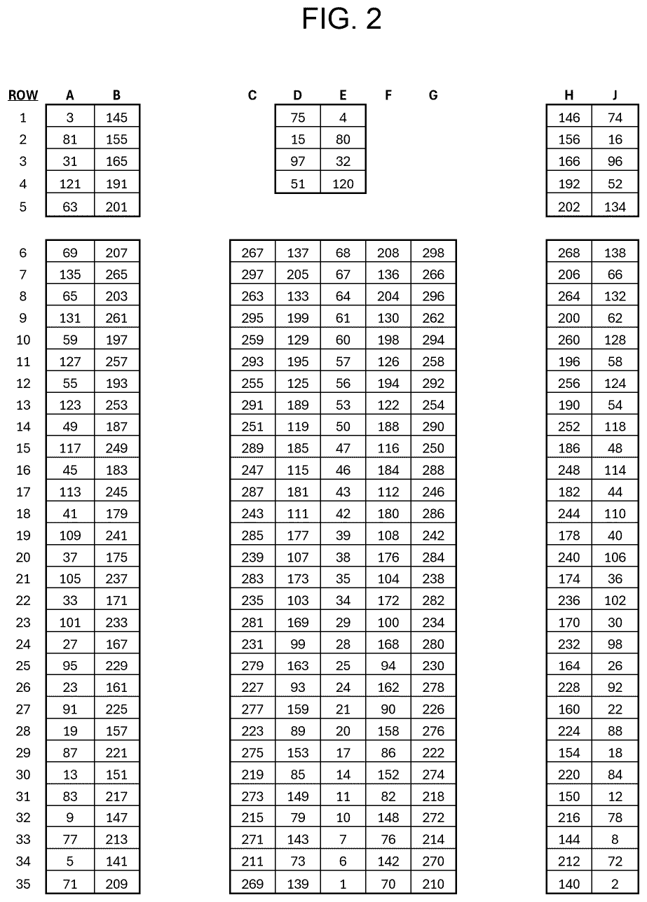

FIG. 2 is an illustration of a seating chart for an airliner with assignments of an initial boarding order calculated as optimal by computer-implemented method and system of the present invention.

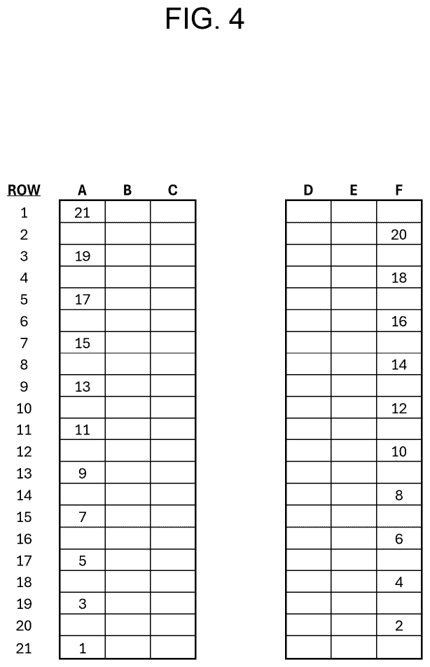

Each seat in the seating chart is assigned a number corresponding to the boarding order calculated as optimal for that seat, in a process described more fully with respect to FIGS. 4-7.

Rows 1-5 are business class and Rows 6-35 are economy. On an airliner with multiple classes of seating, e.g., business and economy, there may be different numbers of seats across a row, as here. There may also be non-standard configurations in rows which may, for example, be adjacent to an aircraft lavatory or a galley, which is illustrated by Row 5 in FIG. 2, which has no middle section.

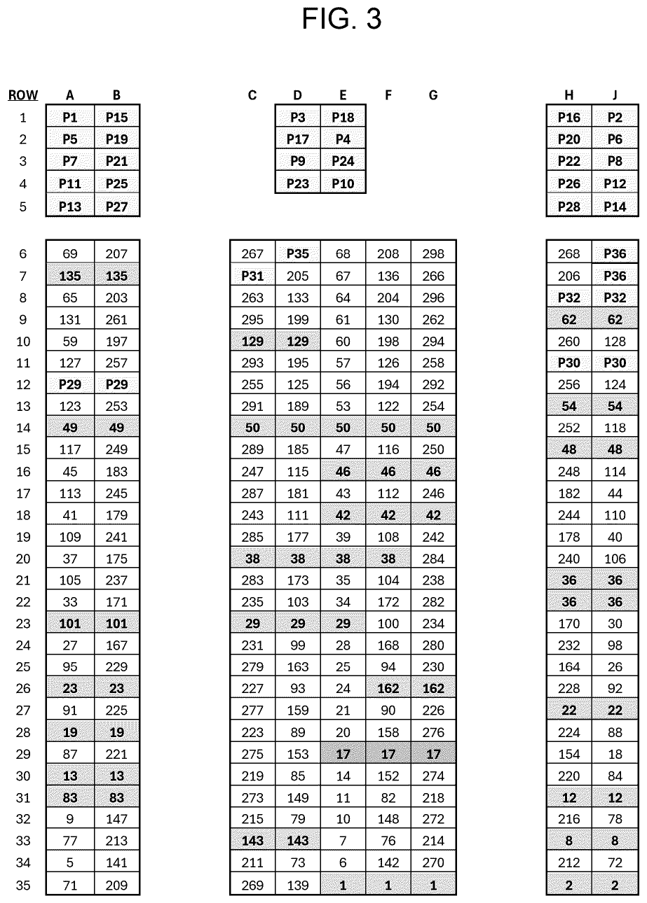

FIG. 3 is an illustration of a seating chart for an airliner with assignments of an initial boarding order calculated as optimal by computer-implemented method and system of the present invention taking into account the needs of passengers traveling together and other airline business considerations such as rewarding high-value customers with priority boarding.

Each plane seat corresponds to an Original Boarding Number as illustrated in FIG. 2. The computer system of the present invention then can take all passengers with the same Record Locator (same ticket/family), and it assigns them each the same Final Boarding Number based on the lowest Original Boarding Number that any of them have. Thus, if a mother, father, and child have Original Boarding Numbers of 1, 70, and 210 based on their seat numbers, the software would assign each of them Final Boarding Number 1, and they would board the plane together in Group 1. Some families may have multiple record locators, and names or loyalty program numbers may also be used to identify passengers traveling together.

The computer system may also assign the travelers a Final Boarding Number equivalent to the highest Original Boarding Number in the group, or the second highest, for example. The computer system may calculate which Final Boarding Number to assign based on a calculation of which Final Boarding Number best optimizes the boarding process as described below with reference to FIGS. 4-7.

Priority passengers would be in Group 0 and would board first (as they currently do). The computer system could also take the pool of passengers who are priority and could have them board in Group 0 and line up in order from the back of the plane first in line to the front of the plane is last in line. Thus, priority passengers could also board efficiently.

FIG. 4 illustrates a step in a boarding process used with embodiments of the present invention.

In this example of a 3-3 seating single aisle configuration with 21 rows, 21 passengers at a time board the plane, stow luggage and then sit down simultaneously. One passenger for each row of six boards at a time, in the first step the window passengers in alternate rows, and no one is held up waiting for a passenger ahead of them to stow their luggage.

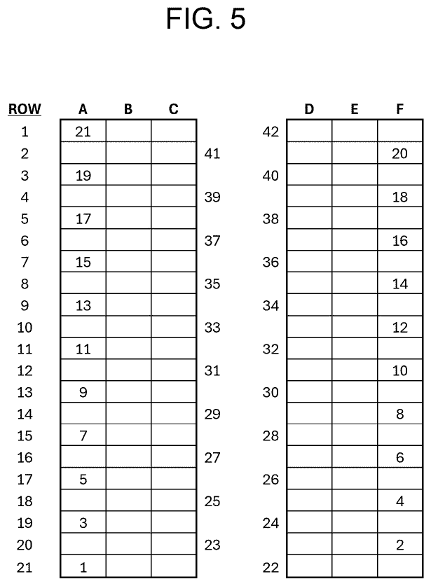

FIG. 5 illustrates another step in a boarding process used with embodiments of the present invention.

Now, 21 more passengers board the aircraft, the window seat passengers on the opposite side of the passengers seated in FIG. 4.

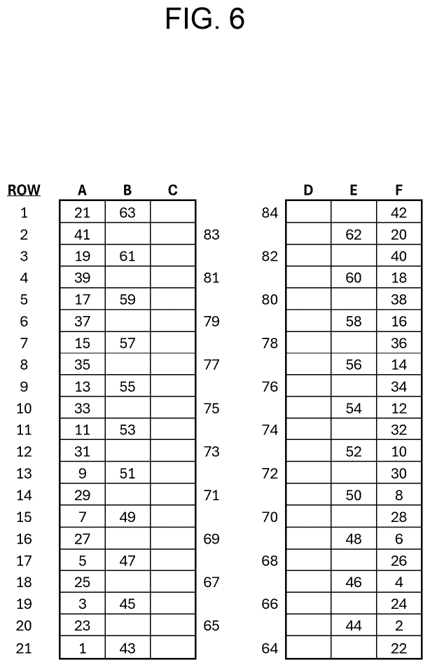

FIG. 6 illustrates the middle seat passengers boarding in a boarding process used with embodiments of the present invention.

Because the window seat passengers have all been seated as described in FIGS. 4-5, no one has to get up and exit their row to allow another passenger to sit down in a window seat. Each passenger has a 2 boarding group interval between when they sit down and when someone sits down next to them.

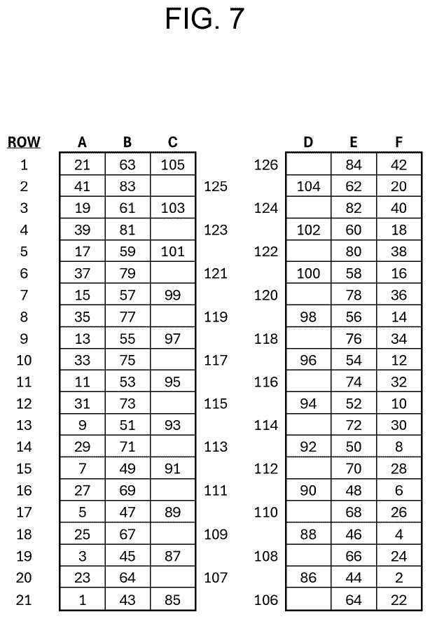

FIG. 7 illustrates another step in a boarding process used with embodiments of the present invention.

Finally, in FIG. 7, the aisle seat passengers are seated in two groups, with similarly all the middle seat passengers seated and similarly no one has to get up to allow anyone to sit down in a middle seat.

Although a 2-2 or 3-3 configuration allows for the computer system of the present invention to easily calculate the ideal boarding process, the computer system can also calculate based on similar principles optimal arrangements for configurations such as 2-3. In a 2-3 configuration for example, the computer system can calculate a boarding process similar to the above but with the final group of aisle passengers on the 3 side boarding last in one group.

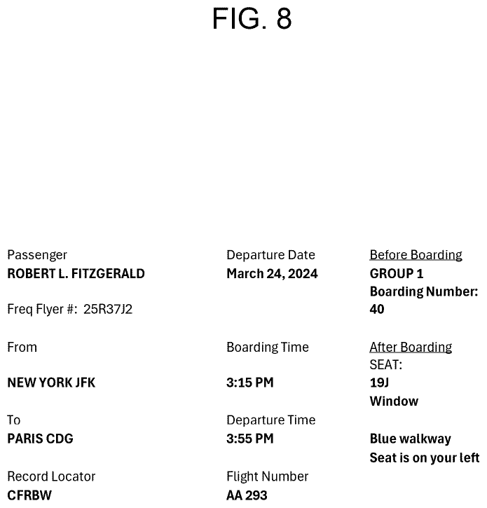

FIG. 8 illustrates a boarding pass used with embodiments of the present invention.

In a twin-aisle plane, passengers can be divided into groups based on the aisle nearest their seat. For example, there could be a red aisle and a blue aisle. The color of the aisle which the passenger is instructed to use is listed on their boarding pass, along with the boarding number assigned according to the process described with reference to FIG. 3 above.

All of the above embodiments can be performed on a computer system having a memory(s) and a processor(s). Additionally, computer readable media storing computer readable code for carrying out the method steps identified above is provided. The computer readable media can store code for carrying out subprocesses for carrying out the methods described above in a variety of formats, such as PHP, Laravel, C++, JavaScript, HTML/CSS, SQL, Python, and Java.

A computer program product recorded on a computer readable medium for carrying out the method steps identified above is provided. The computer program product comprises computer readable means for carrying out the methods described above.

Boarding numbers can be printed using a printer connected to the computer system, or displayed on a display screen, for example, a display screen in a boarding gate. Boarding numbers can also be sent over an electronic communications network and displayed on mobile devices belonging to passengers.

The illustrations of embodiments described herein are intended to provide a general understanding of the structure of various embodiments, and they are not intended to serve as a complete description of all the elements and features of apparatus and systems that might make use of the structures described herein.

Many other embodiments will be apparent to those of skill in the art upon reviewing the above description. Other embodiments may be utilized and derived therefrom, such that structural and logical substitutions and changes may be made without departing from the scope of this disclosure.

Figures are also merely representational and may not be drawn to scale. Certain proportions thereof may be exaggerated, while others may be minimized. Accordingly, the specification and drawings are to be regarded in an illustrative rather than a restrictive sense.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A method of using an aircraft, comprising:
a) a last row window seat passenger on a first side boarding the aircraft first;
b) followed by the second to last row window seat passenger on the opposite side boarding the aircraft next;
c) the third to last row window seat passenger on the first side boarding the aircraft next;
d) continuing boarding such that window seat passengers board from the back of the plane to the front in each group of passengers comprising passengers on the first side and in the next row forward on the alternate side;
e) following the same procedure in a-d by one or more groups of middle seat passengers next; and
f) following the procedure in a-d by one or more groups of aisle seat passengers last.

2. A computer-assisted method for using an aircraft, comprising:
storing logic to minimize interference in seating configurations between passengers while passengers are taking their seats;
storing a flight seating chart for an aircraft on a computer-readable memory device; and
assigning, by using a processor to evaluate the computer memory device based on the stored logic, original boarding numbers for each seat in the flight seating chart to minimize interference.

3. The computer-assisted method for using an aircraft of claim 2, further comprising:
Identifying, by using a processor to evaluate a computer memory device, passengers traveling together based on one or more of name, record locator, and loyalty program number; and
assigning the passengers traveling together each the same Final Boarding Number.

4. The computer-assisted method for using an aircraft of claim 2, further comprising:
identifying a subgroup of priority passengers;
assigning priority passengers a lower Final Boarding Number.

5. The computer-assisted method for using an aircraft of claim 4, wherein the assigned Final Boarding Numbers minimize interference in seating based on the stored logic.

6. The computer-assisted method for using an aircraft of claim 4, further comprising transmitting the Final Boarding Number over an electronic communications system to a passenger mobile device.

7. The computer-assisted method for using an aircraft of claim 2, further comprising subtracting the number of empty seats from the Original Boarding Number.

8. The computer-assisted method for using an aircraft of claim 2, further comprising:
storing a flight seating chart for the aircraft on the computer-readable memory device without empty seats; and
reassigning, by using a processor to evaluate the computer memory device based on the stored logic, original boarding numbers for each seat in the flight seating chart to minimize interference.

9. The computer-assisted method for using an aircraft of claim 4, further comprising transmitting an instruction to a printer to print the Final Boarding Number on a paper boarding pass.
